(19) United States
(12) Patent Application Publication
(10) Pub. No.: US 2004/0146741 A1
(43) Pub. Date: Jul. 29, 2004

(54) Thermal barrier coating

(76) Inventors: Jens Birkner, Mulheim (DE); Werner Stamm, Mulheim (DE)

Correspondence Address: SIEMENS CORPORATION, INTELLECTUAL PROPERTY DEPT., 170 WOOD AVENUE SOUTH, ISELIN, NJ, 08830, US

(21) Appl. No.: 10/756,670

(22) Filed: Jan. 13, 2004

(30) Foreign Application Priority Data
Apr. 24, 2003 (WO) PCT/EP03/04270
May 15, 2002 (EP) 02010837.9

(51) Int. Cl. B23K 1/00

(52) U.S. Cl. 428/689; 228/101

(57) ABSTRACT

Zirconium oxide-based heat insulating layers known in prior art sinter at elevated temperatures while losing the allowance for expansion thereof. The inventive zirconium oxide-based heat insulating layer is provided with admixtures which compensate the reduced allowance for expansion of the zirconium oxide.

The invention relates to a thermal barrier coating as described in claim 1.

Thermal barrier coatings are applied to thermally loaded components, such as for example turbine blades or vanes in gas turbines, in order to protect a heat-sensitive, for example metallic substrate of these components from heat. The thermal barrier coating consists, for example, of zirconium oxide or partially stabilized zirconium oxide with yttrium oxide.

A bonding layer MCrAlY or diffusion layer is often also applied between the thermal barrier coating and the substrate.

EP 1 029 101 B1 shows a thermal barrier coating which has the composition LaAlO₃, i.e. a perovskite.

U.S. Pat. No. 5,310,575 shows a material in which zirconium oxide is admixed in a matrix formed from a spinel.

GB 745,257 discloses a thermal barrier coating, the thermal barrier coating being a spinel, a pyrochlore or zirconium oxide.

U.S. Pat. No. 5,914,189 discloses a thermal barrier coating which is a mixture of a spinel and calcium zirconate (CaZrO₃).

On account of the different expansion coefficients of thermal barrier coating and substrate during operation, stresses are formed, but they do not lead to failure of the layer since there is a certain expansion tolerance on account of a deliberately established microporosity of the thermal barrier coating formed during plasma spraying. In the case of PVD layers (physical vapor deposition) produced by means of electron beams (EB-PVD), there is a columnar structure which is tolerant to expansions. However, on account of the sintering which occurs at the high temperatures of use of around or over 1000° C., these layers lose their expansion tolerance, which increases the risk of the layer failing.

Therefore, it is an object of the invention to provide a thermal barrier coating which overcomes the abovementioned problem.

The object is achieved by a thermal barrier coating as described in claim 1.

Further advantageous configurations of the thermal barrier coating are listed in the subclaims.

The thermal barrier coating according to the invention is a mixture of a matrix material, such as for example zirconium oxide or aluminum oxide, and at least one admixed material that has a reduced sintering potential at the temperatures of use of the thermal barrier coating.

Admixed materials of this nature are preferably ceramics from the systems of the pyrochlores, such as for example La₂Zr₂O₇, La₂Hf₂O₇, and perovskites, such as for example CaZrO₃, LaAlO₃, and spinels, such as for example MgCr₂O₄, MgAl₂O₄, NiAl₂O₄, in an amount of from 10% to 50% by volume.

The matrix material consists, for example, of zirconium oxide (ZrO₂) or partially stabilized zirconium oxide (ZrO₂ and 7%-8% of yttrium oxide (Y₂O₃) or another ceramic.

The admixture to zirconium oxide results in the expansion tolerance automatically being established in the high-temperature range. The expansion coefficients of the admixture used are, by way of example, but not necessarily, above or below the expansion coefficient of the zirconium oxide layer. In the event of sintering of the zirconium oxide matrix, i.e. of matrix shrinkage, the expansion tolerance is locally reduced in the subregion which consists predominantly of zirconium oxide. During use at high temperatures, however, cracks and voids are produced between the particles comprising the admixtures and the zirconium oxide, compensating for the expansion tolerance which has been lost in the zirconium oxide matrix, since the admixtures do not sinter together, i.e. do not shrink or only shrink to a lesser extent, even if the coefficient of thermal expansion is the same.

The influence of the coefficient of thermal expansion of the admixed materials is as follows:

If the matrix material expands to a greater extent than the admixture at high temperatures, compressive stresses are briefly produced but then relax. The sintering which takes place in turn produces porosities and cracks, which generate an increasing porosity.

If the matrix material expands to a lesser extent than the admixture at high temperatures, the sintering of the matrix additionally gives rise to the formation of cracks and porosities between matrix and admixture, compensating for the loss in ductility through the formation of cracks or porosity.

The microporosity/microcracks in the thermal barrier coating is therefore attained by the admixture having a reduced sintering potential and/or by virtue of the matrix and admixture having different expansion coefficients.

A specifically selected mixture makes is possible to set the microstructure in such a way that a porosity which is required for the expansion tolerance of the thermal barrier coating system and a reduction in the hooking together of the columnar structures in the case of EBPVD layers is achieved.

Moreover, the oxygen conductivity can be reduced, so that oxidation of the MCrAlY layer is also reduced.

1. A thermal barrier coating, in particular for use in a gas turbine, characterized in that the thermal barrier coating includes a matrix material, in that materials which have a reduced sintering potential compared to the matrix material at the temperatures of use are admixed with the matrix material.

2. The thermal barrier coating as claimed in claim 1, characterized in that a pyrochlore is admixed with the matrix material.

3. The thermal barrier coating as claimed in claim 2, characterized in that the pyrochlore has the composition La₂ZrO₇ or La₂Hf₂O₇.

4. The thermal barrier coating as claimed in claim 1, characterized in that a perovskite is admixed with the matrix material.

5. The thermal barrier coating as claimed in claim 4, characterized in that the perovskite has the composition CaZrO₃ or LaAlO₃.

6. The thermal barrier coating as claimed in claim 1, characterized in that a spinel is admixed with the matrix material.

7. The thermal barrier coating as claimed in claim 6, characterized in that the spinel has the composition MgZr₂O₄ or MgAl₂O₄ or NiAl₂O₄.

8. The thermal barrier coating as claimed in claim 1, characterized in that the admixtures form from 10%-50% by volume.

9. A thermal barrier coating, in particular as claimed in claim 1, in particular for use in a gas turbine, characterized in that the thermal barrier coating includes a matrix material, in that materials which have a coefficient of thermal expansion which is so different from that of the matrix material at the temperatures of use that microcracks or a microporosity are formed are admixed with the matrix material.

10. The thermal barrier coating as claimed in claim 1 or 9, characterized in that the matrix material is fully stabilized or partially stabilized zirconium oxide.

11. The thermal barrier coating as claimed in claim 1 or 9, characterized in that the matrix material is aluminum oxide.

12. A component having the thermal barrier coating as claimed in claims 1 to 11.
